(19) United States
(12) Patent Application Publication
(10) Pub. No.: US 2004/0049474 A1
(43) Pub. Date: Mar. 11, 2004

(54) Method for combining decision procedures

(75) Inventors: Natarajan Shankar, Los Altos, CA (US); Harald Ruess, Palo Alto, CA (US)

Correspondence Address: Deborah Neville, PO BOX 61063, PALO ALTO, CA, 94306, US

(73) Assignee: SRI INTERNATIONAL, Menlo Park, CA (US)

(21) Appl. No.: 10/447,759

(22) Filed: May 28, 2003

Related U.S. Application Data
(60) Provisional application No. 60/397,201, filed on Jul. 19, 2002.

(51) Int. Cl. G06N 5/02; G06F 17/00; G06N 5/00

(52) U.S. Cl. 706/46; 706/45

(57) ABSTRACT

The method provides a sound and complete online decision method for the combination of canonizable and solvable theories together with uninterpreted function and predicate symbols. It also provides the representation of a solution state in terms of theory-wise solution sets that are used to capture the equality information extracted from the processed equalities. The method includes a context-sensitive canonizer that uses theory-specific canonizers and the solution state to obtain the canonical form of an expression with respect to the given equality information. Moreover, included is the variable abstraction operation for reducing and equality between term to an equality between variables and an enhanced solution state. The closure operation for propagating equality information between solution sets for individual theories uses the theory-specific solvers. The invention teaches a modular method for combining solvers and canonizers into a combination decision procedure. Furthermore, the modular method is useful for integrating Shostak-style decision procedures within a Nelson-Oppen combination so that equality information can be exchanged between theories that are canonizable and solvable, and those that are not. The invention provides a method for deciding a formula with respect to a state comprising: canonizing the formula to create a canonical formula; abstracting the variables in the canonical formula and the state to create an abstracted formula and an abstracted state; asserting the abstracted formula into the abstracted state to create an asserted state; and closing the asserted state.

### RELATED APPLICATIONS

This application claims priority from co-pending U.S. Provisional Application Serial No. 60/397,201 filed Jul. 19, 2002.

### REFERENCE TO GOVERNMENT FUNDING

This invention was made with Government support under Contract Number CA86370-02 awarded by the National Science Foundation. The Government has certain rights in this invention.

### FIELD OF INVENTION

This invention teaches a decision procedure for combination of theories useful in automated deduction.

### BACKGROUND OF THE INVENTION

The following papers provide useful background information, for which they are incorporated herein by reference in their entirety, and are selectively referred to in the remainder of this disclosure by their accompanying reference identifiers in square brackets (i.e., [BDS02] for the second listed paper, by Barrett et al).

[BDL96] Clark Barrett, David Dill, and Jeremy Levitt. Validity checking for combinations of theories with equality. In Mandayam Srivas and Albert Camilleri, editors, Formal Methods in Computer-Aided Design (FMCAD '96), volume 1166 of Lecture Notes in Computer Science, pages 187-201, Palo Alto, Calif., November 1996. Springer-Verlag.

[BDS02] Clark W. Barrett. David L. Dill, and Aaron Stump. A generalization of Shostak's method for combining decision procedures. In A. Armando, editor, Frontiers of Combining Systems, 4th International Workshop, ProCos 2002, number 2309 in Lecture Notes in Artificial Intelligence, pages 132-146, Berlin, Germany, April 2002. Springer-Verlag.

[Bjø99] Nikolaj Bjøner. Integrating Decision Procedures for Temporal Verification. PhD thesis, Stanford University, 1999.

[BS96] F. Baader and K. Schulz. Unification in the union of disjoint equational theories: Combining decision procedures. J. Symbolic Computation, 21: 211-243, 1996.

[BTV02] Leo Bachmair, Ashish Tiwari, and Laurent Vigneron. Abstract congruence closure. Journal of Automated Reasoning, 2002. To appear.

[CLS96] David Cyrluk, Patrick Lincoln, and N. Shankar. On Shostak's decision procedure for combinations of theories. In M. A. McRobbie and J. K. Slaney, editors. Automated Deduction—CADE-13, volume 1104 of Lecture Notes in Artificial Intelligence, pages 463-477, New Brunswick, N.J., July/August 1996. Springer-Verlag.

[DST80] P. J. Downey, R. Sethi, and R. E. Tarjan. Variations on the common subexpressions problem. Journal of the ACM, 27(4):758-771, 1980.

[FORS01] J. C. Fillie,ãtre, S. Owre, H. Rueβ, and N. Shankar. ICS: Integrated Canonization and Solving. In G. Berry, H. Comon, and A. Finkel, editors, Computer-Aided Verification, CAV '2001, volume 2102 of Lecture Notes in Computer Science, pages 246-249, Paris, France, July 2001. Springer-Verlag.

[FS02] Jonathan Ford and Natarajan Shankar. Formal verification of a combination decision procedure. In A. Voronkov, editor, Proceedings of CADE-19, Berlin, Germany, 2002. Springer-Verlag.

[Gan02] Harald Ganzinger. Shostak light. In A. Voronkov, editor, Proceedings of CADE-19, Berlin, Germany, 2002. Springer-Verlag.

[Kap97] Deepak Kapur. Shostak's congruence closure as completion. In H. Comon, editor, International Conference on Rewriting Techniques and Applications, RTA '97, number 1232 in Lecture Notes in Computer Science, pages 23-37, Berlin, 1997. Springer-Verlag.

[Kos77] Dexter Kozen. Complexity of finitely presented algebras. In Conference Record of the Ninth Annual A CM Symposium on Theory of Computing, pages 164-177, Boulder, Colo., May 2-4, 1977.

[Lev99] Jeremy R. Levitt. Formal Verification Techniques for Digital Systems. PhD thesis, Stanford University, 1999.

[N079] G. Nelson and D. C. Oppen. Simplification by cooperating decision procedures. ACM Transactions on Programming Languages and Systems, 1(2):245-257, 1979.

[N080] G. Nelson and D. C. Oppen. Fast decision procedures based on congruence closure. Journal of the ACM, 27(2):356-364, 1980.

[RS01] Harald Rueβ and Natarajan Shankar. Deconstructing Shostak. In 16th Annual IEEE Symposium on Logic in Computer Science, pages 19-28, Boston, Mass., July 2001. IEEE Computer Society.

[Sha01] Natarajan Shankar. Using decision procedures with a higher-order logic. In Theorem Proving in Higher Order Logics: 14th International Conference, TPHOLs 2001, volume 2152 of Lecture Notes in Computer Science, pages 5-26, Edinburgh, Scotland, September 2001. Springer-Verlag.

[Sho78] R. Shostak. An algorithm for reasoning about equality. Comm. ACM, 21:583-585, July 1978.

[Sho84] Robert E. Shostak. Deciding combinations of theories. Journal of the ACM, 31(1):1-12, January 1984.

[Tiw00] Ashish Tiwari. Decision Procedures in Automated Deduction. PhD thesis, State University of New York at Stony Brook, 2000.

A decision procedure determines if a given logical formula is valid. Such formulas can be built from

1. Variables: x, y, z, etc.

2. Function symbols like addition (+) and multiplication (*)

3. Predicate symbols like those for equality (=) and inequality (<, >, ≦, ≧)

4. Propositional connectives for negation ( [symbol] ), conjunction ( [symbol] ), disjunction ( [symbol] ), and implication ( [symbol] ), and

5. Universal and existential quantifiers (∀, ∃).

A ground decision procedure deals solely with quantifier-free formulas where all the variables in the formula are implicitly universally quantified at the outermost level. Since a quantifier-free formula can be placed into conjunctive normal form as a conjunction of disjunctions (clauses) consisting of atomic formulas (equalities, inequalities, etc.) and their negations, it is sufficient to separately determine the validity of each such clause. The validity of a clause l₁ [symbol] . . . [symbol] lₙ, where each lᵢ is either an atomic formula or its negation, can be decided by determining the satisfiability of [symbol] l₁ [symbol] . . . [symbol] [symbol] lₙ. The latter conjunction is unsatisfiable if and only if the former disjunction is valid.

The function and predicate symbols in a formula may be uninterpreted, such that the formula can be satisfied by assigning any interpretation (i.e., meaning of the symbol within the rules of a given theory) to these symbols. Some of the function and predicate symbols can also be interpreted with respect to a theory that assigns the symbol a specific interpretation. For example, one usual interpretation of the function symbol “+” corresponds to the arithmetic meaning (addition) of the symbol and if assigned this interpretation it cannot be assigned the same interpretation as other operations, like those of taking maximum or minimum of two numbers. Formulas can contain a mixture of symbols that are uninterpreted or from one of several theories such as those for arithmetic, lists, arrays, and bit-vectors. Many proof obligations arising from applications such as automated verification, program optimization, and test-case generation, involve constraints from a combination of theories. A combination decision procedure is one that can decide formulas in a combination of theories, and a combination method is one that can be used to assemble a combination decision procedure from individual decision procedures. In the inventive method, the individual theories must be disjoint, so that no function symbol is interpreted in more than one theory. However this is not a problem in practice, as a preprocessing step can be used to disambiguate symbols through, for example, typechecking to differentiate a use of “+” as arithmetic addition and list concatentation.

Ground decision procedures for combination of theories are used in many systems for automated deduction. Two basic paradigms exist for combining decision procedures: Nelson Oppen and Shostak. The Nelson Oppen method combines decision procedures for disjoint theories by exchanging the equality information on the shared variables. In Shostak's method, the combination of the theory of pure equality with canonizable and solvable theories is decided through an extension of congruence closure, that yields a canonizer for the combined theory. However, Shostak's method and all subsequent implementations and use of the method are seriously flawed. What is needed is a correct method to combine multiple disjoint canonizable solvable theories within a Shostak-like framework.

### SUMMARY OF THE INVENTION

The invention addresses the satisfiability of conjunctions of equalities and disequalities. It is based on the Shostak approach of using canonizers and solvers, and handles the general combination of several theories and uninterpreted symbols. It is sound, in the sense that when it asserts that a formula is unsatisfiable, the formula is indeed unsatisfiable. It is also complete and terminating. The decision procedure is an online method, in that it processes each equality or disequality as it given and either signals a contradiction indicating unsatisfiability, or constructs a state capturing the information contained in the given formulas. The state S consists of a solution set Sᵢ for each theory θᵢ and a solution set S_{V} for equalities between variables. The state thus constructed is used to construct a canonizer S[[a]], an operation that simplifies a given expression a to a canonical form a′ so that two expressions that are equal under the given information possess the same canonical form. The critical challenge in the construction of such a canonizer is that of computing a canonical form for a variable x given that such a variable might have a solution in more than one component solution set. The solution returned by the canonizer is context-sensitive so that if x occurs as ƒ(x) for a symbol ƒ from theory θᵢ, then the solution for x from Sᵢ is used.

Each input formula is either an equality a=b or a disequality a≠b. Each input equality is processed with respect to the current state to yield a new state. A disequality a≠b is checked with respect to the new state s by computing the canonical forms s[[a]] and s[[b]] and checking if they are identical. An input equality a=b is processed by first computing the canonical forms a′=b′, where a′ is s[[a]] and b′ is s[[b]]. The canonized equality a′=b′ is then variable abstracted. Variable abstraction is applied to a′=b′ by successively replacing each maximally pure subterm c by a new variable x and adding x=c to the theory θ corresponding to c. A maximally pure subterm of the equality is one whose function symbols are all from a single theory θ and that is not a subterm of some other pure term. Variable abstraction eventually turns the equality a′=b′ into an equality between variables x=y. This equality can be added to S_{V} to merge the partitions corresponding to variables x and y. This merger can lead to further equalities since the solutions aₓ and a_{y} for x and y, respectively, in some solution set Sᵢ might be distinct. A closure operation is used to propagate the equality of x and y to Sᵢ by solving the equality aₓ=a_{y} using solveᵢ and composing the solution into Sᵢ. The use of the solver might yield a contradiction, as in an attempt to solve z=z+1. The closure operation can also yield new equalities between variables that are propagated back to S_{V}. The closure operation is applied repeatedly until no further equalities are left to be propagated. The resulting closed state S either contains an explicit contradiction or is in a form that is suitable for use in the canonizer.

The method provides a sound and complete online decision method for the combination of canonizable and solvable theories together with uninterpreted function and predicate symbols. It also provides the representation of a solution state in terms of theory-wise solution sets that are used to capture the equality information extracted from the processed equalities. The method includes a context-sensitive canonizer that uses theory-specific canonizers and the solution state to obtain the canonical form of an expression with respect to the given equality information. Moreover, included is the variable abstraction operation for reducing and equality between term to an equality between variables and an enhanced solution state. The closure operation for propagating equality information between solution sets for individual theories uses the theory-specific solvers. The invention teaches a modular method for combining solvers and canonizers into a combination decision procedure. Furthermore, the modular method is useful for integrating Shostak-style decision procedures within a Nelson-Oppen combination so that equality information can be exchanged between theories that are canonizable and solvable, and those that are not.

The invention provides a method for deciding a formula with respect to a state comprising: canonizing the formula to create a canonical formula; abstracting the variables in the canonical formula and the state to create an abstracted formula and an abstracted state; asserting the abstracted formula into the abstracted state to create an asserted state; and closing the asserted state. In one aspect, the invention further provides a further step of signaling a contradiction between the formula and the state, indicating unsatisfiability of the formula. In another aspect, the method of the invention may be used as a decision procedure within a Nelson-Oppen framework. Preferred embodiments of the invention perform abstraction by reducing an equality between terms to an equality between variables and an enhanced solution state. Further preferred embodiments of the invention are operable in a modular manner so as to combine solvers and canonizers into a combination decision procedure. In another aspect, the formula to be decided contains uninterpreted function and predicate symbols; and in another aspect the formula contains symbols from more than one interpreted theory. In preferred embodiments of the invention the interpreted theory is selected from the group consisting of arithmetic, lists, arrays and bitvectors. Preferred embodiments of the invention are operable in an online manner so as to process each formula as it is given. In another aspect, the formula to be decided is a proof obligation resulting from an application selected from the group consisting of automated verification, program optimization and test case generation.

Further provided is a method for closing a set of sets of formulas, such set of sets containing a variable equality state set, an uninterpreted theory state set and one or more theory state sets comprising: merging any equalities present in the one or more theory state sets that are not present in the variable equality state set into the variable equality state set and into the uninterpreted theory state set; merging any equalities present in the variable equality state set that are not present in the one or more theory state sets into said one or more theory state sets; and normalizing the one or more theory state sets. In another aspect, the step of merging any equalities present in the variable equality state set that are not present in the one or more theory state sets merges the equality after the application of a theory-specific solver.

The invention also provides a method for canonizing a term with respect to a theory state comprising: canonizing all subterms of the term to create canonical subterms; interpreting said canonical subterms to create interpreted canonical subterms; creating a second term from the application of the operator of the first term to the interpreted canonical subterms; applying a theory specific canonizer to the second term to create a theory specific canonized term; determining if the theory specific canonized term is the right hand side of an equality in said theory state and if so returning the left hand side of the equality, otherwise returning the theory specific canonized term.

### BRIEF DESCRIPTION OF THE DRAWINGS

FIG. 1 is a flow chart illustrative of the inventive method.

FIG. 2 is a flow chart that schematically illustrates the inventive method.

FIG. 3 is a flow chart that further illustrates the inventive method of FIGS. 1 and 2.

### DETAILED DESCRIPTION OF THE INVENTION

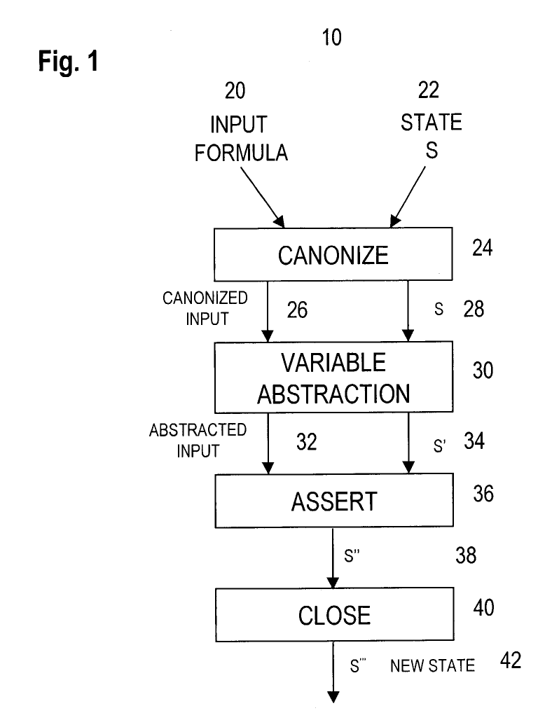

FIG. 1 is a flow chart that schematically illustrates a method for deciding a formula 20 with respect to a state 22 comprising: at step 24, canonizing the formula to create a canonical formula 26; at step 30, abstracting the variables in the canonical formula 26 and the state 28 to create an abstracted formula 32 and an abstracted state 34; at step 36, asserting the abstracted formula 32 into said abstracted state 34 to create an asserted state 38; and at step 40 closing the asserted state 38, where closing means repeating the close step 40 until there is no further change in state.

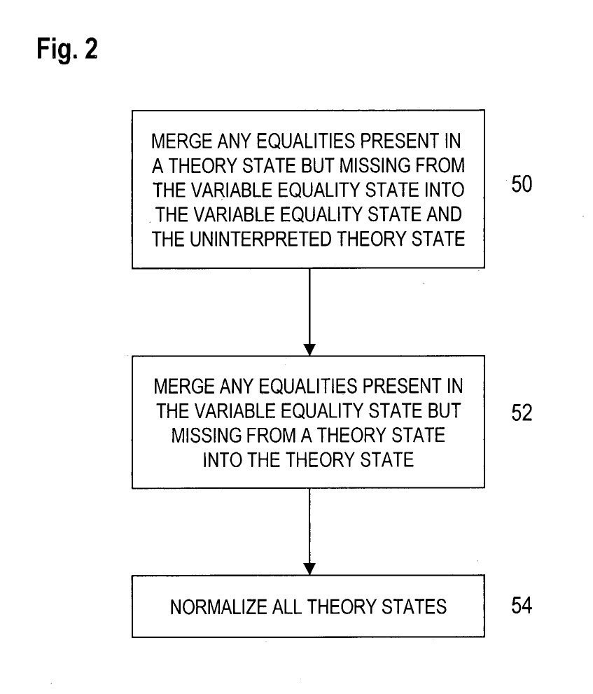

FIG. 2 schematically illustrates a method for closing a set of sets of formulas, such set of sets containing a variable equality state set, an uninterpreted theory state set and one or more theory state sets comprising: at step 50, merging any equalities present in the one or more theory state sets that are not present in the variable equality state set into the variable equality state set and into the uninterpreted theory state set; at step 52, merging any equalities present in the variable equality state set that are not present in the one or more theory state sets into one or more theory state sets; and at step 54, normalizing the one or more theory state sets.

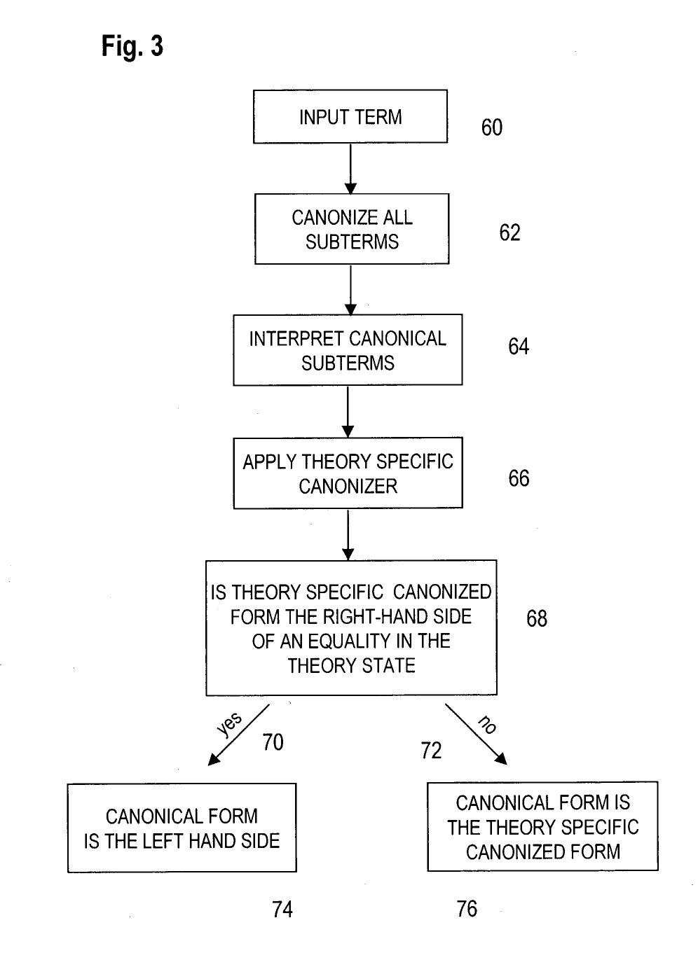

FIG. 3 schematically illustrates a method for canonizing a term provided at step 60 with respect to a theory state comprising: at step 62 canonizing all subterms of the term to create canonical subterms; at step 64, interpreting said canonical subterms to create interpreted canonical subterms and creating a second term from the application of the operator of the first term to the interpreted canonical subterms; at step 66, applying a theory specific canonizer to the second term to create a theory specific canonized term; at step 68, determining if the theory specific canonized term is (70) or is not (72) the right hand side of an equality in the theory state and if so returning the left hand side of the equality at step 74, otherwise returning the theory specific canonized term at step 76.

Consider the sequent

2*car(x)−3*cdr(x)=ƒ(cdr(x))

ƒ(cons(4*car(x)−2*ƒ(cdr(x)),y))=ƒ(cons(6*cdr(x),y)).

It involves symbols from three different theories. The symbol ƒ is uninterpreted, the operations * and − are from the theory of linear arithmetic, and the pairing and projection operations cons, car, and cdr, are from the theory of lists (using the traditional names from the Lisp programming language). There are two basic methods for building combined decision procedures for disjoint theories, i.e., theories that share no function symbols. Nelson and Oppen [NO79] gave a method for combining decision procedures through the use of variable abstraction for replacing subterms with variables, and the exchange of equality information on the shared variables. Thus, with respect to the example above, decision procedures for pure equality, linear arithmetic, and the theory of lists can be composed into a decision procedure for the combined theory. The other combination method, due to Shostak, yields a decision procedure for the combination of canonizable and solvable theories, based on the congruence closure procedure. Shostak's original algorithm and proof were seriously flawed. His algorithm is neither terminating nor complete (even when terminating). These flaws went unnoticed for a long time even though the method was widely used, implemented, and studied [CLS96, BDL96, Bjø99]. In earlier work [RSO1], a correct algorithm was described for the basic combination of a single canonizable, solvable theory with the theory of equality over uninterpreted terms. That correctness proof has been mechanically verified using PVS [FS02]. The generality of the basic combination (i.e., its applicability to multiple theories) rests on Shostak's claim that it is possible to combine solvers and canonizers from disjoint theories into a single canonizer and solver. This claim is easily verifiable for canonizers, but is false for the case of solvers. Using the inventive method, earlier decision procedures may be extended to the combination of uninterpreted equality with multiple canonizable, solvable theories. The decision procedure does not require the combination of solvers. Proofs for the termination, soundness, and completeness of the procedure are included.

2 Preliminaries

Some basic terminology is needed to understand Shostak style decision procedures. Fixing a countable set of variables X and a set of function symbols F, a term is either a variable x from X or a n-ary function symbol ƒ from F applied to n terms as in ƒ(a₁, . . . aₙ). Equations between terms are represented as a=b. Let vars(a), vars(a=b), and vars(T) represent the sets of variables in a, a=b, and the set of equalities T, respectively. Of interest is deciding the validity of sequents of the form T|−c=d where c and d are terms, and T is a set of equalities such that vars(c=d)⊂vars(T). The condition vars(c=d)⊂vars(T) is there for technical reasons. It can always be satisfied by padding T with reflexivity assertions x=x for any variables x in vars(c=d)−vars(T). One writes ┌a┐ for the set of subterms of a, which includes a.

The semantics for a term a, written as M[a]ρ, is given relative to an interpretation M over a domain D and an assignment ρ. For an n-ary function ƒ, the interpretation M(ƒ) of ƒ in M is a map from Dⁿ to D. For an uninterpreted n-ary function symbol ƒ, the interpretation M(ƒ) may be any map from Dⁿ to D, whereas only restricted interpretations might be suitable for an interpreted function symbol like the arithmetic+operation. An assignment ρ is a map from variables in X to values in D. M[a]ρ is defined to return a value in D by means of the following equations.

M[x]ρ=ρ(x)

M[ƒ(a₁, . . . , aₙ)]ρ=M(ƒ)(M[a₁]ρ, . . . , M[aₙ]ρ)

It is said that M,ρ [symbol] a=b iƒƒM[a]ρ=M[b]ρ, and M [symbol] a=b iƒƒM, ρ [symbol] a=b for all assignments ρ. It is written M,ρ [symbol] S when ∀a,b: a=b∈S [symbol] M, ρ [symbol] a=b, and M,ρ [symbol] (T [symbol] a=b) when (M,ρ [symbol] T) [symbol] (M,ρ [symbol] a=b). A sequent T [symbol] c=d is valid, written as [symbol] (T [symbol] c=d), when M,ρ [symbol] T [symbol] c=d), for all M and ρ.

There is a simple pattern underlying the class of decision procedures studied here. Let ψ be the state of the decision procedure as given by a set of formulas.¹ Let τ be a family of state transformations so that ψ [symbol] ψ′ if ψ′ is the result of applying a transformation in τ to ψ, where vars(ψ)⊂vars(ψ′) (variable preservation). An assignment ρ′ is said to extend ρ over vars(ψ′)−vars(ψ) when it agrees with ρ on all variables except those in vars(ψ′)−vars(ψ) for vars(ψ)⊂vars(ψ′). ψ′ preserves ψ if vars(ψ)⊂vars(ψ′) and for all interpretations M and assignments ρ, M, ρ′ [symbol] ψ holds iff there exists an assignment ρ′ extending ρ such that M,ρ′ [symbol] ψ′.² When preservation is restricted to a limited class of interpretations ι, it is said that ψ′ ι-preserves ψ. Note that the preserves relation is transitive. When the operation τ is deterministic, τ(ψ) represents the result of the transformation, and τ is a conservative operation to indicate that τ(ψ) preserves ψ for all ψ. Correspondingly, τ is said to be ι-conservative when τ(ψ) ι-preserves ψ. Let τⁿ represent the n-fold iteration of τ, then τⁿ is a conservative operation. The composition, of τ₂∘τ₁ conservative operations τ₁ and τ₂, is also a conservative operation. The operation τ*(ψ) is defined as τⁱ(ψ) for the least i such that τⁱ⁺¹(ψ)=τⁱ(ψ). The existence of such a bound i must be demonstrated for the termination of τ*. If τ is conservative, so is τ*. ¹ The state is actually represented by a list whose elements are sets of equalities. By viewing such a state as the set of equalities corresponding to the union of the sets of equalities contained in it, notation is abused. ² In general, one could allow the interpretation M to be extended to M′ in the transformation from ψ to ψ′ to allow for the introduction of new function symbols, e.g., skolem functions. This abstract design pattern then also covers skolemization in addition to methods like prenexing, clausification, resolution, variable abstraction, and Knuth-Bendix completion.

If τ is a conservative operation, it is sound and complete in the sense that for a formula φ with vars(φ)⊂vars(ψ), [symbol] (ψ├φ) iff [symbol] (τ(ψ)├φ. This is clear since τ is a conservative operation and vars(φ)⊂vars(ψ).

If τ*(ψ) returns a state ψ′ such that [symbol] (ψ′├⊥). where ⊥ is an unsatisfiable formula, then ψ′ and ψ are both clearly unsatisfiable. Otherwise, if ψ′ is canonical, as explained below, [symbol] (ψ├φ) can be decided by computing a canonical form ψ′[φ] for φ with respect to ψ.

3 Congruence Closure

In this section, an exercise is presented for deciding equality over terms where all function symbols are uninterpreted, i.e., the interpretation of these operations is unconstrained. This means that a sequent T├c=d is valid, i.e., [symbol] (T├c=d) iff for all interpretations M and assignments ρ, the satisfaction relation M,ρ [symbol] (T├c=d) holds. Whenever ƒ(a₁, . . . , aₙ) is written, the function symbol ƒ is uninterpreted, and ƒ(a₁, . . . , aₙ) is then said to be uninterpreted. The procedure may be extended to allow interpreted function symbols from disjoint Shostak theories such as linear arithmetic and lists. The congruence closure procedure sets up the template for the extended procedure in Section 5.

The congruence closure decision procedure for pure equality has been studied by Kozen [Koz77], Shostak [Sho78], Nelson and Oppen [NO80], Downey, Sethi, and Tarjan [DST80], and, more recently, by Kapur [Kap97]. Presented here is the congruence closure algorithm in a Shostak-style, i.e., as an online algorithm for computing and using canonical forms by successively processing the input equations from the set T. For ease of presentation, use is made of variable abstraction in the style of the abstract congruence closure technique attributed to Bachmair, Tiwari, and Vigneron [BTV02]. Terms of the form ƒ(a₁, . . . , aₙ) are variable-abstracted into the form ƒ(x₁, . . . , xₙ) where the variables x₁, . . . , xₙ abstract the terms a₁, . . . , aₙ, respectively. The procedure shown here can be seen as a specific strategy for applying the abstract congruence closure rules. In Section 5, essential use is made of variable abstraction in the Nelson-Oppen style where it is not merely a presentation device.

Let T={a₁=b₁, . . . , aₙ=bₙ} for n≧0 so that T is empty when n=0. Let x and y be metavariables that range over variables. The state of the algorithm consists of a solution state S and the input equalities T. The solution state S will be maintained as the pair (S_{V}; S_{U}), where (l₁; l₂; . . . ; lₙ) represents a list with n elements and semi-colon is an associative separator for list elements. The set S_{U} then contains equalities of the form x=ƒ(x₁, . . . , xₙ) for an n-ary uninterpreted function ƒ, and the set S_{V} contains equalities of the form x=y between variables. The distinction is blurred between the equality a=b and the singleton set {a=b}. Syntactic identity is written as a≡b as opposed to semantic equality a=b.

A set of equalities R is functional if b≡c whenever a=b∈R and a=c∈R, for any a, b, and c. If R is functional, it can be used as a lookup table for obtaining the right-hand side entry corresponding to a left-hand side expression. Thus R(a)=b if a=bεR, and otherwise, R(a)=a. The domain of R, dom(R) is defined as {a|a=b∈R for some b}. When R is not necessarily functional, R({a}) is used to represent the set {b|a=b∈R [symbol] b≡a} which is the image of {a} with respect to the reflexive closure of R. The inverse of R, written as R⁻¹, is the set {b=a |a=b∈R}. A functional set R of equalities can be applied as in R[a].

R[x]=R[x]

R[ƒ(a₁, . . . , aₙ)]=R(ƒ(R[a₁], . . . , R[aₙ]))

R[{a₁=b₁, . . . , aₙ=bₙ}]={R[a₁]=R[b₁], . . . , R[aₙ]=R[bₙ]}

In typical usage, R will be a solution set where the left-hand sides are all variables, so that R[a] is just the result of applying R as a substitution to a.

When S_{V} is functional, then S given by (S_{V}; S_{U}) can also be used to compute the canonical form S[a] of a term a with respect to S. Hilbert's epsilon operator is used in the form of the when operator: F(\overline{x}) when \overline{x}: P(\overline{x}) is an abbreviation for F(ε\overline{x}: P(\overline{x})), if ∃\overline{x}: P(\overline{x}).

S[x]=S_{V}(x)

S[ƒ(a₁, . . . , aₙ)]=S_{V}(x), when x: x=ƒ(S[a₁], . . . , S[aₙ])∈S_{U}

S[ƒ(a₁, . . . , aₙ)]=ƒ(S[a₁], . . . , S[aₙ]), otherwise.

The set S_{V} of variable equalities will be maintained so that vars(S_{V})∪vars(S_{U})=dom(S_{V}). The set S_{V} partitions the variables in dom(S_{V}) into equivalence classes. Two variables x and y are said to be in the same equivalence class with respect to S_{V} if S_{V}(x)≡S_{V}(y). If R and R′ are solution sets and R′ is functional, then R [symbol] R′={a=R′[b]|a=b∈R}, and R∘R′=R′∪(R [symbol] R′). The set S_{V} is maintained in idempotent form so that S_{V}∘S_{V}=S_{V}. Note that S_{U} need not be functional since it can, for example, simultaneously contain the equations x=ƒ(y), x=ƒ(z), and x=g(y).

Assume a strict total ordering x [symbol] y on variables. The operation orient(x=y) returns {x=y} if x [symbol] y, and returns {y=x}, otherwise. The solution state S is said to be congruence-closed if S_{U}({x})∩S_{U}({y})=∅ whenever S_{V}(x)≢S_{V}(y). A solution set S is canonical if S is congruence-closed, S_{V} is functional and idempotent, and S_{U} is normalized, i.e., S_{U} [symbol] S_{V}=S_{U}.

In order to determine if [symbol] (T├c=d), check if S′[c]≡S′[d] for S′ process(S;T), where S=(S_{V};S_{U}), S_{V}=id_{T}, id_{T}={x=x|x∈vars(T)}, and S_{U}=∅. The congruence closure procedure process is defined in Illustration 1.

Explanation. The congruence closure procedure is explained using the validity of the sequent ƒ(ƒ(ƒ(x)))=x, x=ƒ(ƒ(x))├ƒ(x)=x as an example. Its validity will be verified by constructing a solution state S′ equal to process(S_{V}; S_{U}; T) for T {ƒ(ƒ(ƒ(x)))=x, x=ƒ(ƒ(x))}, S_{V}=id_{T}, S_{U}=∅, and checking S′[ƒ(x)]≡S′[x]. Note that id_{T} is (x=x). In processing ƒ(ƒ(ƒ(x)))=x with respect to S, the canonization step, S[ƒ(ƒ(ƒ(x)))=x] process(S;∅)=S

process(S; {a=b}∪T)=process(S′;T), where,

S′=close*(merge(abstract*(S;S[a=b]))).

close(S)=merge(S;S_{V}(x)=S_{V}(y)),

when x,y: S_{V}(x)≢S_{V}(y),(S_{U}({x})∩S_{U}({y})≠∅)

close(S)=S, otherwise.

merge(S;x=x)=S

merge(S;x=y)=(S′_{V};S′_{U}), where x≢y,R=orient(x=y),

S′_{V}=S_{V}∘R,S′_{U}=S_{U} [symbol] R.

abstract(S;x=y)=(S;x=y)

abstract(S;a=b)=(S′;a′=b′), when S′,a′, b′,x₁, . . . , xₙ:

ƒ(x₁, . . . , xₙ)∈[a=b]

x∈vars(S;a=b)

R=(x=ƒ(x₁, . . . , xₙ)},

S′=(S_{V}∪{x=x}; S_{U}∪R),

a′=R⁻¹[a],b′=R⁻¹[b].

### Illustration 1. Congruence Closure

yields ƒ(ƒ(ƒ(x)))=x, unchanged. Next, the variable abstraction step computes abstract*(ƒ(ƒ(ƒ(x)))=x). First ƒ(x) is abstracted to ν₁ yielding the state {x=x, ν₁=ν₁}; {ν₁=ƒ(x)}; {ƒ(ƒ(ν₁))=x}. Variable abstraction eventually terminates renaming ƒ(ν₁) to ν₂ and ƒ(ν₂) to ν₃ so that S is {x=x, ν₁=ν₁, ν₂=ν₂, ν₃=ν₃}; {ν₁=ƒf(x), ν₂=ƒ(ν₁), ν₃=ƒ(ν₂)}. The variable abstracted input equality is then ν₃=x. Let orient(ν₃=x) return ν₃=x. Next, merge(S; ν₃=x) yields the solution state {x=x, ν₁=ν₁, ν₂=ν₂, ν₃=x); {ν₁=ƒ(x), ν₂=ƒ(ν₁), ν₃=ƒ(ν₂)}. The congruence closure step close*(S) leaves S unchanged since there are no variables that are merged in S_{U} and not in S_{V}.

The next input equality x=ƒ(ƒ(x)) is canonized as x=ν₂ which can be oriented as ν₂=x and merged with S to yield the new value {x=x, ν₁=ν₁, ν₂=x, ν₃=x}; {ν₁=ƒ(x), ν₂=ƒ(ν₁), ν₃=ƒ(x) for S. The congruence closure step close*(S) now detects that ν₁ and ν₃ are merged in S_{U} but not in S_{V} and generates the equality ν₁=ν₃. This equality is merged to yield the new value of S as {x=x, ν₁=x, ν₂=x, ν₃=x}; {ν₁=ƒ(x), ν₂=ƒ(x), ν₃=ƒ(x)}, which is congruence-closed.

With respect to this final value of the solution state S, it can be checked that S[ƒ(x)]≡x≡S[x].

Invariants. The Shostak-style congruence closure algorithm makes heavy use of canonical forms and this requires some key invariants to be preserved on the solution state S. If vars(S_{V}) ∪vars(S_{U})⊂dom(S_{V}), then vars(S′_{V}) ∪vars(S′_{U})⊂dom(S′_{V}), when S′ is either abstract(S; a=b) or close(S). If S is canonical and a′=S[a], then S_{V}[a′]=a′. If S_{U} [symbol] S_{V}=S_{U},S_{V}[a]=a, and S_{V}[b]=b, then S′_{U} [symbol] S′_{V}=S′_{U} where S′; a′=b′ is abstract(S; a=b). Similarly, if S_{U} [symbol] S_{V}=S_{U}, S_{V}(x)≡x, S_{V}(y)≡y, then S′_{U}∘S′_{V}=S′_{U} for S′=merge(S; x=y). If S_{V} is functional and idempotent, then so is S′_{V}, where S′ is either of abstract(S; a=b) or close(S). If S′=close*(S), then S′ is congruence-closed, and if S_{V} is functional and idempotent, S_{U} is normalized, then S′ is canonical.

Variations. In the merge operation, if S′_{U} is computed as R[S_{U}]instead of S_{U} [symbol] R, then this would preserve the invariant that S_{U}⁻¹ is always functional and S_{V}[S_{U}]=S_{U}. If this is the case, the canonizer can be simplified to just return S_{U}⁻¹(ƒ(S[a₁], . . . , S[aₙ])).

Termination. The procedure process(S; T) terminates after each equality in T has been asserted into S. The operation abstract* terminates because each recursive call decreases the number of occurrences of function applications in the given equality a=b by at least one. The operation close* terminates because each invocation of the merge operation merges two distinct equivalence classes of variables in S_{V}. The process operation terminates because the number of input equations in T decreases with each recursive call. Therefore the computation of process(S; T) terminates returning a canonical solution set S.

Soundness and Completeness. It is necessary to show that [symbol] (T├c=d) [symbol] S′[c]≡S′[d] for S′=process(id_{T}; ∅; T) and vars(c=d)⊂vars(T). This is done by showing that S′ preserves (id_{T}; ∅; T), and hence [symbol] (T├c=d) [symbol] [symbol] (S′├c=d), and [symbol] (S′├c=d) [symbol] S′[c]≡S′[d]. It can easily be established that if process(S; T)=S′, then S′ preserves (S; T). If a′=b′ is obtained from a=b by applying equality replacements from S, then (S; a′=b′) preserves (S; a=b). In particular, [symbol] (S├S[c]=c) holds. The following claims can then be easily verified.

1. (S; S[a=b] preserves (S;a=b).

2. abstract(S;a=b) preserves (S;a=b).

3. merge(S;a=b) preserves (S;a=b).

4. close(S) preserves S.

The only remaining step is to show that if S′ is canonical, then [symbol] (S′├c=d) [symbol] S′[c]≡S′[d] for vars(c=d)⊂vars(S). Since it is known that [symbol] S′├S′[c]=c and [symbol] S′├S′[d]=d, hence [symbol] (S′├c=d) follows from S′[c]≡S′[d]. For the only if direction, it is shown that if S′[c]≢S′[d], then there is an interpretation M_{S′} and assignment ρ_{S′} such that M_{S′}, ρ_{S′} [symbol] S but M_{S′}, ρ_{S′} [symbol] c=d. A canonical term (in S′) is a term a such that S′[a]≡a. The domain D_{S′} is taken to be the set of canonical terms built from the function symbols F and variables from vars(S′). Constrain M_{S′} so that M_{S′}(ƒ)(a₁, . . . , aₙ)=S′_{V}(x) when there is an x such that x=ƒ(a₁, . . . , aₙ)εS′_{U}, and ƒ(a₁, . . . , aₙ), otherwise. Let ρ_{S′} map x in vars(S′) to S′_{V}(x); the mappings for the variables outside vars(S′) are irrelevant. It is easy to see that M_{S′}[c]ρ_{S′}=S′[c] by induction on the structure of c. In particular, when S′ is canonical, M_{S′}(ƒ)(x₁, . . . , xₙ)=x for ƒ(x₁, . . . , xₙ)εS′_{U}, so that one can easily verify that M_{S′}, ρ_{S′} [symbol] S′. Hence, if S′[c]≢S′[d], then [symbol] (S′├c=d).

4 Shostak Theories

A Shostak theory [Sho84] is a theory that is canonizable and solvable. Assume a collection of Shostak theories θ₁, . . . , θ_{N}. In this section, decision procedure is given for a single Shostak theory θᵢ, but with i as a parameter. This background material is adapted from Shankar [Sha01]. Satisfiability M, ρ [symbol] a=b is with respect to i-models M. The equality a=b is i-valid, i.e., [symbol] ᵢa=b, if for all i-models M and assignments ρ, M[a]ρ=M[b]ρ. Similarly, a=b is i-unsatisfiable, i.e., [symbol] ᵢa≠b, when for all i-models M and assignments ρ, M[a]≠M[b]ρ. An i-term a is a term whose function symbols all belong to θᵢ and vars(a)⊂X∪Xᵢ.

A canonizable theory θᵢ admits a computable operation σᵢ on terms such that [symbol] ᵢa=b iff σᵢ(a)≡σᵢ(b), for i-terms a and b. An i-term a is canonical if σᵢ(a)≡a. Additionally, vars(σᵢ(a))⊂vars(a) and every subterm of σᵢ(a) must be canonical. For example, a canonizer for the theory θ_{A} of linear arithmetic can be defined to convert expressions into an ordered sum-of-monomials form. Then, σ_{A}(y+x+x)≡2*x+y≡σ_{A}(x+y+x).

A solvable theory admits a procedure solveᵢ on equalities such that solveᵢ(Y)(a=b) for a set of variables Y with vars(a=b)⊂Y, returns a solved form for a=b as explained below. solveᵢ(Y)(a=b) might contain fresh variables that do not appear in Y. A functional solution set R is in i-solved form if it is of the form {x₁=t₁, . . . , xₙ=tₙ}, where for j, 1≦j≦n, tⱼ is a canonical i-term, σᵢ(tⱼ)≡tⱼ, and vars(tⱼ)∩dom(R)=∅ unless tⱼ≡xⱼ. The i-solved form solveᵢ(Y)(a=b) is either ⊥ᵢ, when [symbol] ᵢa≠b, or is a solution set of equalities which is the union of sets R₁ and R₂. The set R₁ is the solved form {x₁=t₁, . . . , xₙ=tₙ} with xⱼ∈vars(a=b) for 1≦j≦n, and for any i-model M and assignment ρ, M,ρ [symbol] a=b iff there is a ρ′ extending ρ over vars(solveᵢ(Y)(a=b))−Y such that M,ρ′ [symbol] xⱼ=tⱼ, for 1≦j≦n. The set R₂ is just {x=x|x∈vars(R₁)−Y} and is included in order to preserve variables. In other words, solveᵢ(Y)(a=b) i-preserves a=b. For example, a solver for linear arithmetic can be constructed to isolate a variable on one side of the equality through scaling and cancellation. Assume that the fresh variables generated by solveᵢ are from the set Xᵢ. Take vars(⊥ᵢ) to be X∪Xᵢ, so as to maintain variable preservation, and indeed ⊥ᵢ could be represented as just ⊥ were it not for this condition.

A decision procedure is described for sequents of the form T├c=d in a single Shostak theory with canonizer σᵢ and solver solveᵢ. Here the solution state S is just a functional solution set of equalities in i-solved form. Given a solution set S, define S<<a>>ᵢ as σᵢ(S[a]). The composition of solutions sets is defined so that S∘ᵢ⊥ᵢ=⊥ᵢ∘ᵢS=⊥ᵢ and S∘ᵢR=R∪{a=R<<b>>ᵢ|a=b∈S}. Note that solved forms are idempotent with respect to composition so that S∘ᵢ S=S. The solved form solvecloseᵢ(id_{T}; T) is obtained by processing the equations in T to build up a solution set S. An equation a=b is first canonized with respect to S as S<<a>>ᵢ=S<<b>>ᵢ and then solved to yield the solution R. If R is ⊥ᵢ, then T is i-unsatisfiable and one returns the solution state with Sᵢ=⊥ᵢ as the result. Otherwise, the composition S∘ᵢR is computed and used to similarly process the remaining formulas in T.

solvecloseᵢ(S; ∅)=S

solvecloseᵢ(⊥ᵢ; T)=⊥ᵢ

solvecloseᵢ(S; {a=b}∪T=solvecloseᵢ(S′,T),

where S′=S∘ᵢ solveᵢ(vars(S))(S<<a>>ᵢ=S<<b>>ᵢ)

To check i-validity, [symbol] ᵢ(T├c=d), it is sufficient to check that either

solvecloseᵢ(id_{T}; T)=⊥ or S′<<c>>ᵢ≡S′<<d>>ᵢ, where S′=solvecloseᵢ(id_{T}; T).

Soundness and Completeness. As with the congruence closure procedure, each step in solvecloseᵢ is i-conservative. Hence solvecloseᵢis sound and complete: if S′=solvecloseᵢ(S; T), then for every i-model M and assignment ρ, M, ρ [symbol] S∪T iff there is a ρ′ extending ρ over the variables in vars(S′)−vars(S) such that M,ρ′ [symbol] S′. If σᵢ(S′[a])≡σᵢ(S′[b]), then M,ρ′ [symbol] a=S′[a]=σᵢ(S′[a])=σᵢ(S′[b])=S′[b]=b, and hence M, ρ [symbol] a=b. Otherwise, when σᵢ(S′[a])≢σᵢ(S′[b]), it is known by the condition on σᵢ that there is an i-model M and an assignment ρ′ such that M[S′[a]]ρ′≠M[S′[b]]ρ′. The solved form S′ divides the variables into independent variables x such that S′(x)=x, and dependent variables y where y≠S′(y) and the variables in vars(S′(y)) are all independent. One can therefore extend ρ′ to an assignment ρ where the dependent variables y are mapped to M[S′(y)]ρ′. Clearly, M,ρ [symbol] S′, M,ρ [symbol] a=S′[a], and M,ρ [symbol] b=S′[b]. Since S′ i-preserves (id_{T}; T), M,ρ [symbol] T but M,ρ [symbol] a=b and hence T├a=b is not i-valid, so the procedure is complete. The correctness argument is thus similar to that of Section 3 but for the case of a single Shostak theory considered here, there is no need to construct a canonical term model since [symbol] ᵢ a=σᵢ(a), and σᵢ(a)≡σᵢ(b) iff [symbol] ᵢa=b.

Canonical term model. The situation is different when one wishes to combine Shostak theories. It is important to resolve potential semantic incompatibilities between two Shostak theories. With respect to some fixed notion of i-validity for θᵢ and j-validity for θⱼ with i≠j, a formula A in the union of θᵢ and θⱼ may be satisfiable in an i-interpretation of only a specific finite cardinality for which there might be no corresponding satisfying j-interpretation for the formula. Such an incompatibility can arise even when a theory θᵢ is extended with uninterpreted function symbols. For example, if φ is a formula with variables x and y that is satisfiable only in a two-element model M where ρ(x)≠ρ(y), then the set of formulas Γ where Γ=(φ,ƒ(x)=x, ƒ(u)=y, ƒ(y)=x} additionally requires ρ(x)≠ρ(u) and ρ(y)≠ρ(u). Hence, a model for Γ must have at least three elements, so that Γ is unsatisfiable. However there is no way to detect this kind of unsatisfiability purely through the use of solving and canonization.

A canonical term model is introduced as a way around such semantic incompatibilities. The set of canonical i-terms a such that σᵢ(a)≡a yields a domain for a term model Mᵢ where Mᵢ(ƒ)(a₁, . . . , aₙ)=σᵢ(ƒ(a₁, . . . , aₙ). If Mᵢ is (isomorphic to) an i-model, then the theory θᵢ is composable. Note that the solve operation is conservative with respect to the model Mᵢ as well, since Mᵢ is taken as an i-model.

Given the usual interpretation of disjunction, a notion of validity is said to be convex when [symbol] (T├c₁=d₁ [symbol] . . . [symbol] cₙ=dₙ) implies [symbol] (T├cₖ32 dₖ) for some k, 1≦k≦n. If a theory θᵢ is composable, then i-validity is convex. Recall that [symbol] , i(T├c₁=d₁ [symbol] . . . [symbol] cₙ=dₙ) iff [symbol] ᵢ(S├c₁=d₁ [symbol] . . . [symbol] cₙ=dₙ) for S solvecloseᵢ(id_{T}; T). If S≠⊥ᵢ, then [symbol] ᵢ(T├cₖ=dₖ), for 1≦k≦n. If S≠⊥ᵢ, then since S i-preserves T, [symbol] ᵢ(S├c₁=d₁ [symbol] . . . [symbol] cₙ=dₙ), but (by assumption) [symbol] ᵢ(S├cₖ32 dₖ). An assignment ρ_{S} can be constructed so that for independent (i.e., where S(x)=x) variables xεvars(S), ρ_{S}(x)=x, and for dependent variables y∈vars(S), ρ_{S}(y)=Mᵢ[S(y)]ρ_{S}. If for S≠⊥ᵢ, [symbol] _{σ}, (S├cₖ=dₖ), then Mᵢ, σ_{S} [symbol] cₖ32 dₖ. Hence Mᵢ, ρ_{S} [symbol] (S├cₖ=dₖ), for 1≦k≦n. This yields Mᵢ,ρ_{S} [symbol] (T├c₁=d₁ [symbol] . . . [symbol] cₙ=dₙ), contradicting the assumption.

5 Combining Shostak Theories

The combination of the theory of equality over uninterpreted function symbols with several disjoint Shostak theories is now examined. Examples of interpreted operations from Shostak theories include + and − from the theory of linear arithmetic, select and update from the theory of arrays, and cons, car, and cdr from the theory of lists. The basic Shostak combination algorithm covers the union of equality over uninterpreted function symbols and a single canonizable and solvable equational theory [Sho84, CLS96, RS01]. Shostak [Sho84] had claimed that the basic combination algorithm was sufficient because canonizers and solvers for disjoint theories could be combined into a single canonizer and solver for their union. This claim is incorrect. ³ A combined decision procedure for multiple Shostak theories is presented that overcomes the difficulty of combining solvers. ³ The difficulty with combining Shostak solvers was observed by Jeremy Levitt [Lev99]. . . . (footnote continued)

Two theories θ₁ and θ₂ are said to be disjoint if they have no function symbols in common. A typical subgoal in a proof can involve interpreted symbols from several theories. Let σᵢ be the canonizer for θᵢ. A term ƒ(a₁, . . . , aₙ) is said to be in θᵢ if ƒ is in θᵢ even though some aᵢ might contain function symbols outside θᵢ. In processing terms from the union of pairwise disjoint theories θ₁, . . . , θ_{N}, it is quite easy to combine the canonizers so that each theory treats terms in the other theory as variables. Since σᵢ is only applicable to i-terms, one first has to extend the canonizer σᵢ to treat terms in θⱼ for j≠i, as variables. Treat uninterpreted function symbols as belonging to a special theory θ₀ where σ₀(a)=a for aεθ₀. The extended operation σ′ᵢ is defined below.

σ′ᵢ(a)=R[σᵢ(a′)], when a′,b,R a′ is an i-term,

R is functional,

dom(R)⊂vars(a′),

R(x)εθⱼ, for x∈dom (R), some j≠i,

R[a′]≡a

Note that the when condition in the above definition can always be satisfied. The combined canonizer σ can then be defined as

σ(x)=x

σ(ƒ(a₁, . . . , aₙ))=σ′ᵢ(ƒ(σ(a₁), . . . , σ(aₙ))), when i: ƒ is in θᵢ.

A discussion of the difficulty of combining the solvers solve₁ and solve₂ for θ₁ and θ₂, respectively, into a single solver follows. The example uses the theory θ_{A} of linear arithmetic and the theory θ_{L} of the pairing and projection operations cons, car, cdr, where, somewhat nonsensically, the projection operations also apply to numerical expressions. Shostak illustrated the combination using the example

5+car(x+2)=cdr(x+1)+3.

Since the top-level operation on the left-hand side is +, car(x+2) and cdr(x+1) are treated as variables and use solve_{A}. This might yield a partially solved equation of the form car(x+2)=cdr(x+1)−2. Now because the top-level operation on the left-hand side is from the theory of lists, use solve_{L}, to obtain x+2=cons(cdr(x+1)−2, u) with a fresh variable u. Once again apply solve_{A} to obtain x=cons(cdr(x+1)−2, u)−2. This is, however, not in solved form: the left-hand side variable occurs in an interpreted context in its solution. There is no way to prevent this from happening as long as each solver treats terms from another theory as variables. Therefore the union of Shostak theories is not necessarily a Shostak theory.

The problem of combining disjoint Shostak theories actually has a very simple solution. There is no need to combine solvers. Since the theories are disjoint, the canonizer can tolerate multiple solutions for the same variable as long as there is at most one solution from any individual theory. This can be illustrated on the same example: 5+car(x+2)=cdr(x+1)+3. By variable abstraction, one obtains the equation ν₃=ν₆, where ν₁=x+2, ν₂=car(ν₁), ν₃=ν₂+5, ν₄=x+1, ν_{S}=cdr(ν₄), ν₆=ν₅+3. One can separate these equations out into the respective theories so that S is (S_{V}; S_{U}; S_{A}; S_{L}), where S_{V} contains the variable equalities in canonical form, S_{U} is as in congruence closure but is always ∅ since there are no uninterpreted operations in this example, and S_{A} and S_{L}, are the solution sets for θ_{A} and θ_{L}, respectively. One then gets S_{V}={x=x, ν₁=ν₁, ν₂=ν₂, ν₃=ν₆, ν₄=ν₄, ν₅=ν₅, ν₆=ν₆}, S_{A}={ν₁=x+2, ν₃=ν₂+5, ν₄=x+1, ν₆=ν₅+3}, and S_{L}={ν₂=car(ν₁), ν₅=cdr(ν₄)}. Since ν₃ an ν₆ are merged in S_{V}, but not in S_{A}, solve the equality between S_{A}(ν₃) and S_{A}(ν₆), i.e., solve_{A}(ν₂+5=ν₅+3) to get ν₂=ν₅−2. This result is composed with S_{A} to get {ν₁=x+2, ν₃=ν₅+3, ν₄=x+1, ν₆=ν₅+3, ν₂=ν₅−2} for S_{A}. There are no new variable equalities to be propagated out of either S_{A}, S_{L}, or S_{V}. Notice that ν₂ and ν₅ both have different solved forms in S_{A} and S_{L}. This is tolerated since the solutions are from disjoint theories and the canonizer can pick a solution that is appropriate to the context. For example, when canonizing a term of the form ƒ(x) for ƒεθᵢ, it is clear that the only relevant solution for x is the one from Sᵢ.

It may now be checked whether the resulting solution state verifies the original equation 5+car(x+2)=cdr(x+1)+3. In canonizing ƒ(a₁, . . . , aₙ) return S_{V}(y) whenever the term ƒ(Sᵢ(S[a₁], . . . , Sᵢ(S[aₙ])) being canonized is such that y=ƒ(Sᵢ(S[a₁], . . . , Sᵢ(S[aₙ]))∈Sᵢ for ƒ∈θᵢ. Thus x+2 canonizes to νᵢ using S_{A}, and car(ν₁) canonizes to ν₂ using S_{L}. The resulting term 5+ν₂, using the solution for ν₂ from S_{A}, simplifies to ν₅+3, which returns the canonical form ν₆ by using S_{A}. On the right-hand side, x+1 is equivalent to ν₄ in S_{A}, and car(ν₄) simplifies to ν₅ using S_{L}. The right-hand side therefore simplifies to ν₅+3 which is canonized to ν₆ using S_{A}. The canonized left-hand and right-hand sides are identical.

A formal description of the procedure used informally in the above example is presented, showing how process from Section 3 can be extended to combine the union of disjoint solvable, canonizable, composable theories. Assume that there are N disjoint theories θ₁, . . . , θ_{N}. Each theory θᵢ is equipped with a canonizer σ₁ and solver solveᵢ for i-terms. If I represents the interval [1, N], then an I-model is a model M that is an i-model for each i∈I. This will ensure that each inference step is conservative with respect to I-models, i.e., I-conservative. Represent the uninterpreted part of S as S₀ instead of S_{U}. The solution state S of the algorithm now consists of a list of sets of equations (S_{V}; S₀; S₁; . . . ; S_{N}). Here S_{V} is a set of variable equations of the form x=y, and S₀ is the set of equations of the form x=ƒ(x₁, . . . ,xₙ) where ƒ is uninterpreted. Each Sᵢ is in i-solved form and is the solution set for θᵢ.

Terms now contain a mixture of function symbols that are uninterpreted or are interpreted in one of the theories θᵢ. A solution state S is confluent if for all x, y∈dom(S_{V}) and i, 0≦i≦N: S_{V}(x)≡S_{V}(y) [symbol] Sᵢ({x})∩Sᵢ({y})≠∅. A solution state S is canonical if it is confluent; S_{V} is functional and idempotent, i.e., S_{V}∘S_{V}=S_{V}; the uninterpreted solution set S₀ is normalized, i.e., S₀ [symbol] S_{V}=S₀; each Sᵢ, for i>0, is functional, idempotent, i.e., Sᵢ∘ᵢSᵢ=Sᵢ, normalized i.e., Sᵢ [symbol] S_{V}=Sᵢ, and in i-solved form. The canonization of expressions with respect to a canonical solution set S is defined as follows.

S[x]=S_{V}(x)

abstract(S; x=y)=(S; x=y),

abstract(S; a=b)=(S′; a′=b′),

when S′,c,i: c∈max([a=b],),

x∉vars(S∪a=b),

S′_{V}=S_{V}∪{x=x},

S′ᵢ=Sᵢ∪{x=c},

S′ⱼ=Sⱼ, for, i≠j

a′={C=x}[a],

b′={c=x}[b].

### Illustration 2. Variable Abstraction Step for Multiple Shostak Theories

S [ƒ(a₁, . . . , aₙ)]=S_{V}(x), when i,x:

i≧0,ƒ∈θᵢ,x=σ′ᵢ,(ƒ(Sᵢ(S[a₁]), . . . , Sᵢ(S[aₙ])))∈Sᵢ

S[ƒ(a₁, . . . , aₙ)]=σ′ᵢ(ƒ(Sᵢ(S[a₁]), . . . , Sᵢ(S[aₙ]))), when i: ƒεθᵢ,i≧0.

Since variables are used to communicate between the different theories, the canonical variable x in S_{V} is returned when the term being canonized is known to be equivalent to an expression a such that y=a in Sᵢ, where x≡S_{V}(y). The definition of the above global canonizer is an important aspect of the invention. This definition can be applied to the example above of computing S[5+car(x+2)].

Variable Abstraction. The variable abstraction procedure abstract(S; a=b) is shown in Illustration 2. If a is an i-term such that a∉X, then a is said to be a pure i-term. Let [a=b]ᵢ represent the set of subterms of a=b that are pure i-terms. The set max(M) of maximal terms in M is defined to be {a∈M|a≡b [symbol] a∉[b], for any b ∈M}. In a single variable abstraction step, abstract(S; a=b) picks a maximal pure i-subterm c from the canonized input equality a=b, and replaces it with a fresh variable x from X while adding x=c to Sᵢ. By abstracting a maximal pure i-term, it is ensured that Sᵢ remains in i-solved form.

Explanation. The procedure in Illustration 3 is similar to that of Illustration 1. Equations from the input set T are processed into the solution state S of the form S_{V}; S₀; . . . ; S_{N}. Initially, S must be canonical. In processing the input equation a=b into S, steps are taken to systematically restore the canonicity of S. The first step is to compute the canonical form S[a=b] of a=b with respect to S. It is easy to see that (S; S[a=b]) I-preserves (S; a=b).

The result of the canonization step a′=b′ is then variable abstracted as abstract*(a′=b′) (shown in Illustration 2) so that in each step, a maximal, pure i-subterm c of a′=b′ is replaced by a fresh variable x, and the equality x=c is added to Sᵢ. This is also easily seen to be an I-conservative step. The equality x=y resulting from the variable abstraction of a′=b′ is then merged into S_{V}

process(S; ∅)=S

process(S; T)=S, when i: S_{i=⊥}ᵢ

process(S; {a=b}∪T=process(S′; T), where

S′=close*(merge_{V}(abstract*(S; S[a=b]))).

close(S)=S, when i: Sᵢ=⊥ᵢ

close(S)=S′, when S′,i, x,y:

x,y∈dom(S_{V}),

(i>0, S_{V}(x)≡S_{V}(y), Sᵢ(x)≢Sᵢ(y), and

S′=mergeᵢ(S; x=y)) or

(i≧0,S_{V}(x)≢S_{V}(y)Sᵢ({x}))∪Sᵢ([y])≠∅, and

S′=merge_{V}(S; S_{V}(x)=S_{V}(y)))

close(S)=normalize(S), otherwise.

normalize(S)=(S_{V}; S_{O}; S₁ [symbol] S_{V}; . . . ; S_{N} [symbol] S_{V}).

mergeᵢ(S;x=y)=S′, where i>0,

S′ᵢ=Sᵢ∘ᵢ solveᵢ(vars(Sᵢ))(Sᵢ(x)=Sᵢ(y)),

S′ⱼ=Sⱼ, for i≠j,

S_{V}=S_{V}.

merge_{V}(S; x=x)=S

merge_{V}(S; x=y)=(S_{V}∘R; S_{O} [symbol] R; S₁; . . . ; S_{N}), where R=orient(x=y).

### Illustration 3. Combining Multiple Shostak Theories

and S₀. This can destroy confluence since there may be variables w and z such that w and z are merged in S_{V} (i.e., S_{V}(w)≡S_{V}(z)) that are unmerged in some Sᵢ (i.e., Sᵢ({w})∩Sᵢ({z})=∅), or vice-versa.⁴ The number of variables in dom(S_{V}) remains fixed during the computation of close*(S). Confluence is restored by close*(S) which finds a pair of variables that are merged in some Sᵢ but not in S_{V}, and merging them in S_{V}, or that are merged in S_{V} and not in some Sᵢ and merging them in Sᵢ. Each such merge step is also I-conservative. When this process terminates, S is once again canonical. The solution sets Sᵢ are normalized with respect to S_{V} in order to ensure that the entries are in the normalized form for lookup during canonization. ⁴ For i>0, Sᵢ is maintained in i-solved form and hence, Sᵢ({x})={x, Sᵢ(x)}.

Invariants. As with congruence closure, several key invariants are needed to ensure that the solution state S is maintained in canonical form whenever it is given as the argument to process. If S is canonical and a and b are canonical with respect to S, then for (S′; a′=b′)=abstract(S; a=b), S′ is canonical, and a′ and b′ are canonical with respect to S′. The state abstract(S; a=b) I-preserves (S; a=b). A solution state is said to be well-formed if S_{V} is functional and idempotent, S₀ is normalized, and each Sᵢ is functional, idempotent, and in solved form. Note that if S is well-formed, confluent, and each Sᵢ, is normalized, then it is canonical. When S is well-formed, and S′=merge_{V}(S; x=y) or S′=mergeᵢ(S; x=y), then S′ is well-formed and I-preserves (S; x=y). If S is well-formed and congruence-closed, and S′=normalize(S), then S′ is well-formed and each S′ᵢ is normalized. If S′=normalize(S), then each S′ᵢ is in solved form because if x replaces y on the right-hand side of a solution set Sᵢ, then Sᵢ(y)≡y since Sᵢ is in i-solved form. By congruence closure, Sᵢ(x)≡Sᵢ(y)≡y. Therefore, the uniform replacement of y by x ensures that S′ᵢ(x)≡x, thus leaving S in solved form. If S′=close*(S), where S is well-formed, then S′ is canonical.

Variations. As with congruence closure, once S is confluent, it is safe to strengthen the normalization step to replace each Sᵢ by S_{V}[Sᵢ]. This renders Sₒ⁻¹ functional, but Sᵢ⁻¹ may still be non-functional for i>0, since it might contain left-hand side variables that are local. However, if Sᵢ is taken to be Sᵢ restricted to dom(S_{V}), then Sᵢ⁻¹ with the strengthened normalization is functional and can be used in canonization. The solutions for local variables can be safely discarded in an actual implementation. The canonization and variable abstraction steps can be combined within a single recursion.

Termination. The operations S[a=b] and abstract*(S; a=b) are easily seen to be terminating. The operation close*(S) also terminates because the sum of the number of equivalence classes of variables in dom(S_{V}) with respect to each of the solution sets S_{V}, S₀, S₁, . . . , S_{N}, decreases with each merge operation.

Soundness and Completeness. It has already been seen that each of the steps: canonization, variable abstraction, composition, merging, and normalization, is I-conservative. It therefore follows that if S′=process(S; T), then S′ I-preserves S. Hence, if S′[c]≡S′[d], then clearly [symbol] ₁(S′├c=d), and hence [symbol] ₁(S; T├c=d).

The completeness argument requires the demonstration that if S′[c]≢S′[d], then [symbol] ₁(S′├c=d) when S′ is canonical. This is done by means of a construction of M_{S′}and ρ_{S′}, such that M_{S′}, ρ_{S′} [symbol] S′ but M_{S′}, ρ_{S′} [symbol] c=d. The domain D consists of canonical terms e such that S′[e]=e. As with congruence closure, M_{S′} is defined so that M_{S′}(ƒ)(e₁, . . . , eₙ.)=S′[ƒ(e₁, . . . , eₙ)]. The assignment ρ_{S} is defined so that ρ_{S′}(x)=S_{V}(x). By induction on c, M_{S′}[c]ρ_{S′}=S′[c]. One may easily check that M_{S′}, ρ_{S′} [symbol] S′.

It is also the case that M_{S′} is an I-model since M_{S′} is isomorphic to Mᵢ for each i, 1≦i≦N. This can be demonstrated by constructing a bijective map μᵢ between D and the domain Dᵢ corresponding to Mᵢ. Let Pᵢ be the set of pure I-terms in D, and let γ be a bijection between D−Pᵢ and X such that γ(x)=x if S′ᵢ(x)=x for x∈dom(S′_{V}). Define μᵢ so that μᵢ(x)=S′ᵢ(x) for x∈dom(S′_{V}) and S′_{V}(x)=x, μᵢ(y)=y for y∈Xᵢ, μᵢ (ƒ(a₁, . . . , aₙ))=ƒ(μᵢ (a₁), . . . , μᵢ(aₙ)) for ƒεθᵢ, and μᵢ(a)=γ(a), otherwise. It can then be verified that for an i-term a, μᵢ(M_{S′}[a]ρ)=Mᵢ[a]ρᵢ, where ρᵢ(x)=μᵢ(ρ(x)). This concludes the proof of completeness.

Convexity revisited. As in Section 4, the term model construction of M_{S′} once again establishes that I-validity is convex. In other words, a sequent [symbol] ₁(T├c₁=d₁V . . . V cₙ=dₙ) iƒƒ [symbol] ₁(T├cₖ32 dₖ) for some k, 1≦k≦n.

Ground decision procedures for equality are crucial for discharging the myriad proof obligations that arise in numerous applications of automated reasoning. These goals typically contain operations from a combination of theories, including uninterpreted symbols. Shostak's basic method deals only with the combination of a single canonizable, solvable theory with equality over uninterpreted function symbols. Indeed, in all previous work based on Shostak's method, only the basic combination is considered. Though Shostak asserted that the basic combination was adequate to cover the more general case of multiple Shostak theories, this claim has turned out to be false. Given here is the first Shostak-style combination method for the general case of multiple Shostak theories.

The inventive method, in the embodiment described herein, is clearly an instance of a Nelson-Oppen combination [N079] because it involves the exchange of equalities between variables through the solution set S_{V}, but with the added advantage of a Shostak combination in that it combines the canonizers of the individual theories into a global canonizer. The definition of such a canonizer for multiple Shostak theories is unique to the inventive method. The technique of achieving confluence across the different solution sets is also unique to the inventive method. Confluence is needed for obtaining useful canonical forms, and is therefore not essential in a general Nelson-Oppen combination. The global canonizer S[a] can be applied to input formulas to discharge queries and simplify input formulas. The reduction to canonical form with respect to the given equalities helps keep the size of the term universe small, and makes the algorithm more efficient than a black box Nelson-Oppen combination. The decision algorithm for a Shostak theory given in Section 4 fits the requirements for a black box procedure that can be used within a Nelson-Oppen combination. The Nelson-Oppen combination of Shostak theories with other decision procedures has been studied by Tiwari [Tiw00], Barrett, Dill, and Stump [BDS02], and Ganzinger [Gan02], but none of these methods includes a general canonization procedure as is required for a Shostak combination.

Variable abstraction is also used in the combination unification procedure of Baader and Schulz [BS96], which addresses a similar problem to that of combining Shostak solvers. In the inventive method, there is no need to ensure that solutions are compatible across distinct theories. Furthermore, variable dependencies can be cyclic across theories so that it is possible to have y∈vars(Sᵢ(x)) and x∈vars(Sⱼ(y)) for i≠j. The inventive algorithm can be easily and usefully adapted for combining unification and matching algorithms with constraint solving in Shostak theories.

Insights derived from the Nelson-Oppen combination method have been crucial in the design of the inventive algorithm and its proof. Proof of the basic algorithm additionally demonstrated the existence of proof objects in a sound and complete proof system [RS01]. This can easily be replicated for the embodiment of the general algorithm described herein. The soundness and completeness proofs given herein are for composable theories and avoid the use of σ-models.

The inventive Shostak-style algorithm fits modularly within the Nelson-Oppen framework. It can be employed within a Nelson-Oppen combination in which there are other decision procedures that generate equalities between variables. It is also possible to combine it with decision procedures that are not disjoint, as for example with linear arithmetic inequalities. Here, the existence of a canonizer with respect to equality is useful for representing inequality information in a canonical form. A variant of the procedure described here has been reduced to practice in ICS™ (a software product of the assignee of the present invention) [FORS01] in exactly such a combination.

It will be appreciated that the preferred embodiments described above are cited by way of example, and that the invention is not limited to what has been particularly shown and described hereinabove. Rather, the scope of the invention includes both combinations and subcombinations of the various features described hereinabove, as well as variations and modifications thereof not disclosed in the prior art and which would occur to persons skilled in the art upon reading the foregoing description.

What is claimed is:

1. A method for deciding a formula with respect to a state comprising:
canonizing said formula to create a canonical formula;
abstracting the variables in said canonical formula and said state to create an abstracted formula and an abstracted state;
asserting said abstracted formula into said abstracted state to create an asserted state; and
closing the asserted state.

2. A method as in claim 1 further comprising the step of signaling a contradiction between the formula and the state, indicating unsatisfiability of the formula.

3. A method as in claim 1 for deciding a formula with respect to a state wherein said method is used as a decision procedure within a Nelson-Oppen framework.

4. A method as in claim 1 wherein said step of abstracting the variables in said canonical formula comprises reducing an equality between terms to an equality between variables and an enhanced solution state.

5. A method as in claim 1 wherein said method is operable in a modular manner so as to combine solvers and canonizers into a combination decision procedure.

6. A method as in claim 1 wherein said formula contains uninterpreted function and predicate symbols.

7. A method as in claim 1 wherein said formula contains symbols from more than one interpreted theory.

8. A method as in claim 7 wherein the interpreted theory is selected from the group consisting of arithmetic, lists, arrays and bitvectors.

9. A method as in claim 1 wherein the method is operable in an online manner so as to process each formula as it is given.

10. A method as in claim 1 wherein the formula is a proof obligation resulting from an application selected from the group consisting of automated verification, program optimization and test case generation.

11. A method for closing a set of sets of formulas, such set of sets containing a variable equality state set, an uninterpreted theory state set and one or more theory state sets comprising:
merging any equalities present in the one or more theory state sets that are not present in the variable equality state set into the variable equality state set and into the uninterpreted theory state set;
merging any equalities present in the variable equality state set that are not present in the one or more theory state sets into said one or more theory state sets; and
normalizing the one or more theory state sets.

12. A method as in claim 11 wherein the step of merging any equalities present in the variable equality state set that are not present in the one or more theory state sets merges the equality after the application of a theory-specific solver.

13. A method for canonizing a term with respect to a theory state comprising:
canonizing all subterms of the term to create canonical subterms;
interpreting said canonical subterms to create interpreted canonical subterms;
creating a second term from the application of the operator of the first term to the interpreted canonical subterms;
applying a theory specific canonizer to the second term to create a theory specific canonized term;
determining if the theory specific canonized term is the right hand side of an equality in said theory state and if so returning the left hand side of said equality, otherwise returning the theory specific canonized term.
